(19) United States
(12) Patent Application Publication
(10) Pub. No.: US 2005/0231533 A1
(43) Pub. Date: Oct. 20, 2005

(54) Apparatus and method for performing divide by w operations in a graphics system

(76) Inventor: Lin Chen, Fremont, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/827,983

(22) Filed: Apr. 20, 2004

(51) Int. Cl. G06T 15/00; G06T 17/20; G06T 15/30; G09G 5/00

(52) U.S. Cl. 345/643; 345/419

(57) ABSTRACT

The present invention is generally directed to a system and method for transforming a plurality of points from a homogeneous coordinate representation, where the points are defined by x, p, and w values, wherein x represents a geometric coordinate value, p represents any arbitrary attribute value, and w represents a homogeneous coordinate value. In one embodiment, the method comprising, for each point: (1) determining whether the w value for the point is zero, (2) setting a flag and not dividing the x or p values by w, if w is zero, and (3) dividing each of the x and p values by w, if w is not zero. A graphics system is also provided having various logic components for carrying out the above operations.

### FIELD OF THE INVENTION

The present invention generally relates to graphics systems, and more particularly to an apparatus and method for performing divide by w operations in a graphics system, where w represents a homogeneous coordinate value.

### BACKGROUND

As is known, the art and science of three-dimensional (“3-D”) computer graphics concerns the generation, or rendering, of two-dimensional (“2-D”) images of 3-D objects for display or presentation onto a display device or monitor, such as a Cathode Ray Tube (CRT) or a Liquid Crystal Display (LCD). The object may be a simple geometry primitive such as a point, a line segment, a triangle, or a polygon. More complex objects can be rendered onto a display device by representing the objects with a series of connected planar polygons, such as, for example, by representing the objects as a series of connected planar triangles. All geometry primitives may eventually be described in terms of one vertex or a set of vertices, for example, coordinate (x, y, z) that defines a point, for example, the endpoint of a line segment, or a corner of a polygon.

To generate a data set for display as a 2-D projection representative of a 3-D primitive onto a computer monitor or other display device, the vertices of the primitive are processed through a series of operations, or processing stages in a graphics-rendering pipeline. A generic pipeline is merely a series of cascading processing units, or stages, wherein the output from a prior stage serves as the input for a subsequent stage. In the context of a graphics processor, these stages include, for example, per-vertex operations, primitive assembly operations, pixel operations, texture assembly operations, rasterization operations, and fragment operations.

In a typical graphics display system, an image database (e.g., a command list) may store a description of the objects in the scene. The objects are described with a number of small polygons, which cover the surface of the object in the same manner that a number of small tiles can cover a wall or other surface. Each polygon is described as a list of vertex coordinates (X, Y, Z in “Model” coordinates) and some specification of material surface properties (i.e., color, texture, shininess, etc.), as well as possibly the normal vectors to the surface at each vertex. For three-dimensional objects with complex curved surfaces, the polygons in general must be triangles or quadralaterals, and the latter can always be decomposed into pairs of triangles.

A transformation engine transforms the object coordinates in response to the angle of viewing selected by a user from user input. In addition, the user may specify the field of view, the size of the image to be produced, and the back end of the viewing volume so as to include or eliminate background as desired.

Once this viewing area has been selected, clipping logic eliminates the polygons (i.e., triangles) which are outside the viewing area and “clips” the polygons, which are partly inside and partly outside the viewing area. These clipped polygons will correspond to the portion of the polygon inside the viewing area with new edge(s) corresponding to the edge(s) of the viewing area. The polygon vertices are then transmitted to the next stage in coordinates corresponding to the viewing screen (in X, Y coordinates) with an associated depth for each vertex (the Z coordinate). In a typical system, the lighting model is next applied taking into account the light sources. The polygons with their color values are then transmitted to a rasterizer.

For each polygon, the rasterizer determines which pixel positions are covered by the polygon and attempts to write the associated color values and depth (Z value) into frame buffer. The rasterizer compares the depth values (Z) for the polygon being processed with the depth value of a pixel, which may already be written into the frame buffer. If the depth value of the new polygon pixel is smaller, indicating that it is in front of the polygon already written into the frame buffer, then its value will replace the value in the frame buffer because the new polygon will obscure the polygon previously processed and written into the frame buffer. This process is repeated until all of the polygons have been rasterized. At that point, a video controller displays the contents of a frame buffer on a display a scan line at a time in raster order.

As is known, during the graphics processing and rendering operations, a number of transformations and other operations are performed, which utilize homogenous coordinates. As is further known, homogeneous coordinates and projective geometry bear the same relationship. Specifically, homogeneous coordinate provide a method for performing calculations (e.g., translations, rotations, scaling, etc.) in projective geometry. Conversion from, for example, three-dimensional Cartesian coordinates (x, y, z) to Homogeneous coordinates involves the addition of an additional variable (w).

Homogeneous coordinates provide a method (or mechanism) to perform certain standard operations on points in Euclidean space by means of matrix multiplications. Typically, points are converted into Homogeneous coordinates, and then various transformations are performed, before conversion back to non-Homogenous coordinates. This transformation from Homogeneous coordinates can be performed by dividing by w (the Homogeneous coordinate value). Problems arise, however, when w=0 (which represents a point at a distance of infinity. Previous systems and methods typically accommodate this problem by substituting a very small value in place of w, when w=0. While this effectively avoids the divide by zero issue, it injects an error (even if only slight) into the result.

Accordingly, what is desired is an improved apparatus and method for performing transformation from homogeneous coordinate systems that are able to effectively manage w=0 situation, without injecting errors in the numerical result.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve the advantages and novel features, the present invention is generally directed to a system and method for transforming a plurality of points from a homogeneous coordinate representation, where the points are defined by x, p, and w values, wherein x represents a geometric coordinate value, p represents any arbitrary attribute value, and w represents a homogeneous coordinate value. In one embodiment, the method comprising, for each point: (1) determining whether the w value for the point is zero, (2) setting a flag and not dividing the x or p values by w, if w is zero, and (3) dividing each of the x and p values by w, if w is not zero.

### DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a block diagram illustrating certain components in a graphics pipeline constructed in accordance with certain embodiments of the invention.

FIG. 2 is a block diagram illustrating certain components in the triangle setup component of FIG. 1, and in accordance with an embodiment of the present invention.

FIG. 3 is a graph illustrating the computation of a slope for an arbitrary attribute in comparison to a geometric coordinate, as utilized by computations of embodiments of the present invention.

FIG. 4 is a block diagram illustrating certain logic components of an embodiment of the present invention.

FIG. 5 is a block diagram illustrating the selection, by a multiplexer, for the logical processing of certain operations in accordance with an embodiment of the present invention.

### DETAILED DESCRIPTION

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

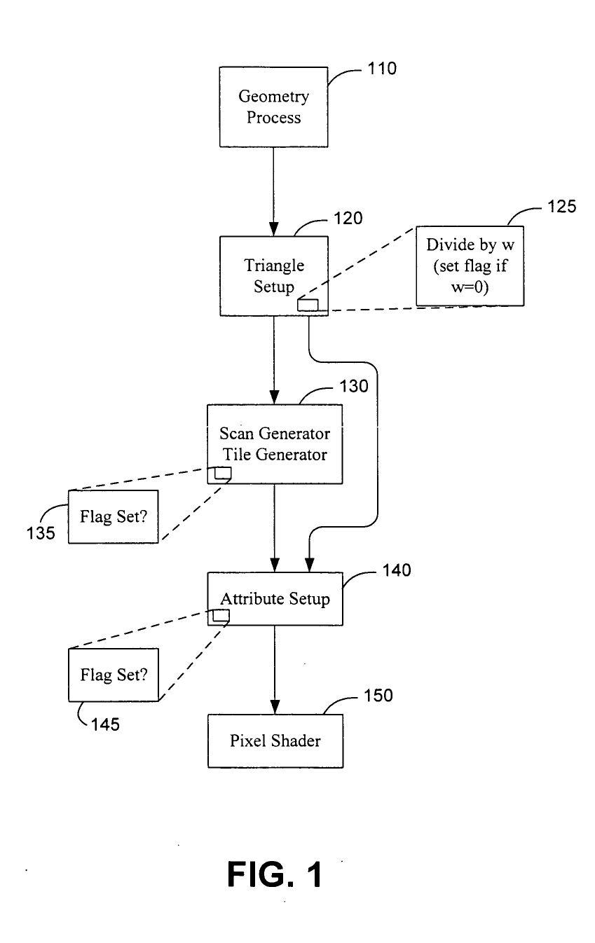

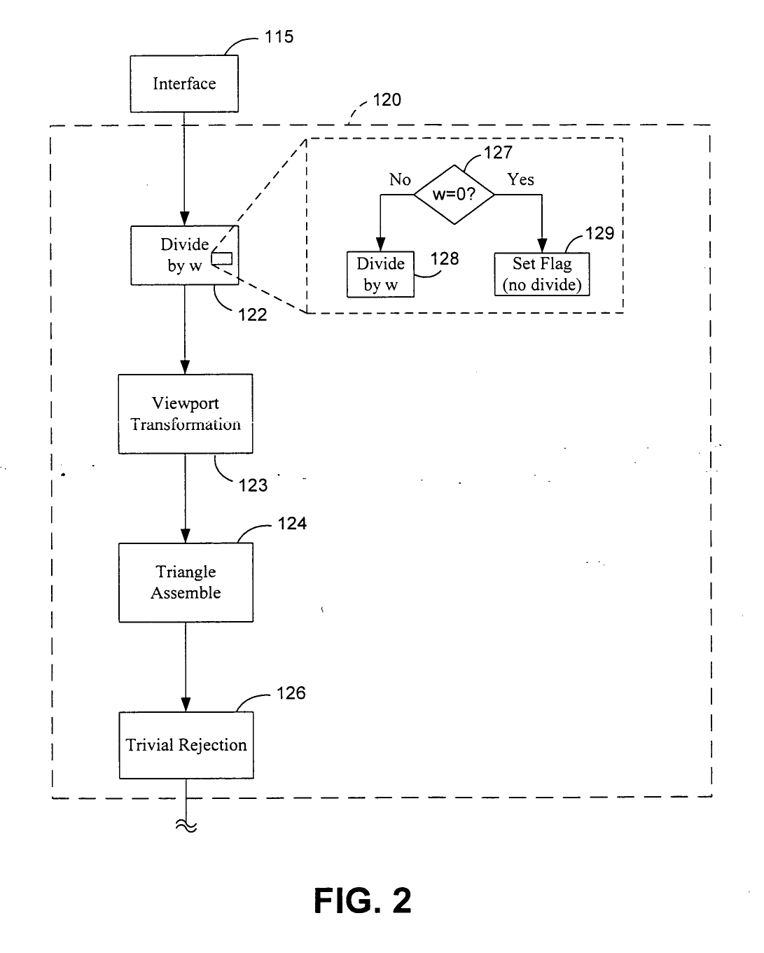

As summarized above, the present invention is directed to a novel system and method for handling transformation computations when w (a homogeneous coordinate value) is zero. Before discussing implementation details of various embodiments, reference is made to FIG. 1, which is a block diagram illustrating certain components in a graphics pipeline, which may be utilized by or in embodiments of the present invention. The principle components illustrated in FIG. 1 are a geometry process 110, triangle setup 120, scan and tile generator 130, and attribute setup block 140, and a pixel shader 150. The general function and operation of these components are known and understood by persons skilled in the art, and therefore need not be described in detail herein. To summarize, however, the geometry process 110 refers to a process that may be operating on a host computer, which results in the generation of graphics data (such as geometry data) that may be fed into a graphics pipeline for rendering and display on a computer display (not shown). Geometry and other graphics data generated by the geometry process data 110 is communicated to logic 120 for performing a triangle setup operation. Specific functions and implementation details of the triangle setup 120 may vary from embodiment to embodiment. In general, vertex information about triangle primitives may be passed to the triangle setup logic 120, and operations may be performed on the various primitives defined by the graphics data that is passed to the triangle setup logic 120. Among other operations, and as illustrated in FIG. 2, certain geometry transformations may be performed within the triangle setup logic 120.

By way of illustration, for a given vertex, geometry data such as x, y, z, and w information may be provided (where x, y, and z are geometric coordinates, and w is the homogenous coordinate). As is known by persons skilled in the art, various transformations may be made from, for example; model space to world space to eye space, to projection space, to homogeneous space, to normalized device coordinates (or NDC), and finally to screen space (performed by a viewport transformation).

Again, these various transformations are well-known by persons skilled in the art, and need not be described herein. In this regard, and as is known, the conversion from homogeneous coordinates to normalized device coordinates includes a divided by w operation. This operation is straight-forward for situations in which the value of w is not equal to zero (the vast majority of situations). However, a divide by zero (illegal operation) problem arises for situations in which w is equal to zero. An embodiment of the present invention handles this situation by setting (or clearing) a flag and skipping the division operation. In such circumstances, the geometry operation is left in homogeneous coordinate space.

Downstream logic blocks may check the status of the flag, before performing certain operations. In this way, the status or value of the flag indicates which coordinates the data is currently in, so appropriate and accurate computations and transformation may be made.

In an embodiment of the present invention, logic 125 for performing this operation (e.g., determining if w is zero, and if so, sending an appropriate flag) is incorporated as a part of the triangle setup logic 120. Of course, in other embodiments, the logic 125 may be implemented outside of the triangle setup logic 120. Companion logic 135 and 145 is provided downstream of the triangle setup logic 120 for determining whether the w equals zero flag is set or not. That is, when the relevant data is operated on by downstream logic elements, those elements will preferably ascertain whether the data was maintained in homogeneous coordinates or if the transformation to normalized device coordinates and/or screen coordinates had been performed. This determination may be made by evaluation of the flag that was set by logic 125. One location such a check or comparison may be made is in the attribute setup logic 140. As is known, various attributes (e.g., texture, fog, transparency, etc.) may be associated with various graphic primitives and pixels. Certain attribute setup operations are performed by logic 140 prior to the operation of the pixel shader (which determines color information for each of the pixels within the primitive that are to be displayed on the display). Since the pixel attributes are identified in connection with geometry data for the pixel, it is preferred that the system perform operations on the relevant pixels with knowledge of the relevant coordinate system. This knowledge is ascertained by evaluating the flag to determine whether it was set or not. In embodiments of the invention, similar logic 135 may be implemented within the scan and tile generator logic 130.

Reference is now made to FIG. 2, which is a block diagram illustrating certain logic elements that may be implemented within the triangle setup 120 of an embodiment of the invention. Interface logic 115 may be provided for interfacing the triangle setup logic with the geometry process 110. Certain conventional logic components within the triangle setup 120 include logic 122 for performing the divide by w operation, logic 123 for performing a view port transformation, logic 124 for performing the triangle assembly, and logic 126 for performing trivial rejections of the primitives, where appropriate (e.g., where it is determined from depth or other information that the entire primitive is not visible to the user). In accordance with an embodiment of the invention, the divide by w logic 122 may include logic 127 for determining whether the current value of w is zero. If not, then logic 128 may perform a conventional divide by w operation. If, however, w is determined to be zero, then logic 129 may set a flag and perform no divide by w operation. In such a situation, the view port transformation 123 for the associated primitive may be bypassed.

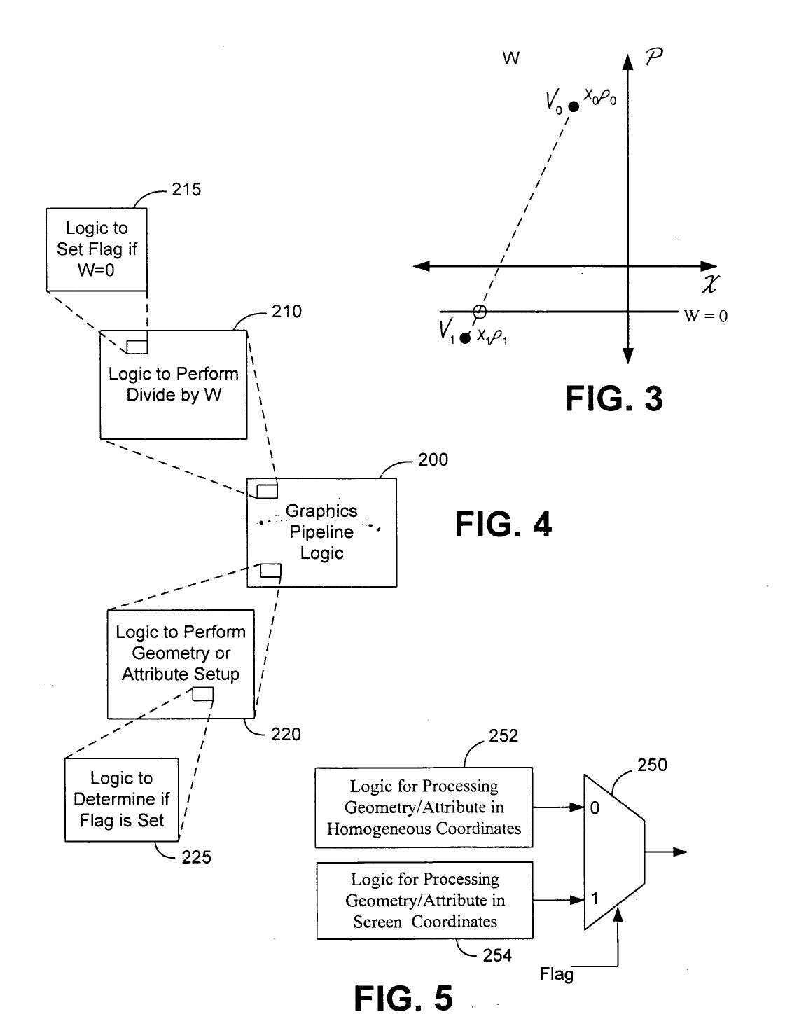

What is significant for purposes of the illustrated embodiment is the identification and the setting of a flag (when w equals zero), so that downstream components can take appropriate action when performing operations on the attributes associated with such pixels or other geometric data. In this regard, reference is made to FIG. 3, which is a graph that helps illustrate the handling of the attribute setup operation for w equals zero situations. For simplicity, the graph is illustrated in only one geometric dimension (x) but may be readily expanded to additional dimensions as well. The following pseudo-code is provided, in conjunction with the graph of FIG. 3, to illustrate one methodology for handling the attribute calculation, which accommodates for the divide-by-w situation. In the following pseudo-code segment,

“//” designate non-operational comments.

//Divide by w stage
//P is attribute
//Q is attribute in screen space (P divide by w)
if (w==0)

//don't do divide, but set a flag
set flag WZERO

else

Q = P / W //do normal divide, and keep WZERO flag cleared

//Attribute setup stage
//Suppose W0 !=0, W1 ==0
if (WZERO)

delta = P1/X1 //if WZERO flag was previously set, calculate
“delta” (slope

of attribute line) by computing P1/X1 in homogenous
coordinate space

else

delta = dQ/dX = (Q1 − Q0) / (X1 − X0)

//if WZERO flag was not previously set, calculate “delta”
as the change in Q over the change in X, as the conversion
to screen space was previously performed

//Interpolation stage
Q = Q0 + (X − X0) * delta

As can be readily verified, whether w was zero or non-zero, the attribute is ultimately computed with a result in screen space. Further, the interpolation performed by the illustrated methodology is uniform, and the inaccuracies otherwise injected by substituting non-zero values in place of W, when w equal zero, are avoided. Further, a flag is used in the preferred embodiment of the invention as a one-bit flag provides a convenient methodology or mechanism for communicating the relevant information to downstream processing blocks. In this regard, in certain embodiments, various downstream blocks will need to know this information. Such downstream blocks may include a triangle determinant calculation (DET), edge calculations performed by the scan and tile generator, and attribute setup operations. While in many systems the w value may be passed to the attribute setup block, it is often not passed to the triangle determinant calculation or the edge calculation. However, a one bit value is an easily-manageable additional piece of information that may be readily passed to these blocks.

Consistent with the scope and spirit of the embodiments described herein, the term “flag” should be accorded a very broad definitional construction, as a mechanism for providing a binary or true/false indication (e.g., whether w=0 or not). Also, for purposes of implementation, it is irrelevant whether the flag is “set” or “cleared” to indicate the situation of w=0.

Reference is now made to FIG. 4, which is a block diagram illustrating certain components of an embodiment of the invention. In the embodiment of FIG. 4, a graphics pipeline includes graphics pipeline logic 200. In addition to a variety of standard or conventional logic components, the graphics pipeline logic also includes logic 210 to perform a divide by w operation. As a part of this logic 210, additional logic 215 is provided to set a flag if w is determined to be zero, and the divide by w operation for that graphic element is omitted. Companion logic is provided downstream to perform various operations on the graphic elements. These operations may include geometry or attribute setup operations. Logic 225 is provided to determine whether the w equal zero flag has been set for a given graphic element. If not, operations on that element may be processed in screen space as a transformation into screen space would have been performed previously within the graphics pipeline logic 200. Alternatively, the processing of the graphic element may be performed in homogeneous coordinates before performing a transformation into screen coordinates.

One mechanism for implementing this latter feature is illustrated in FIG. 5, in which the value of the flag may be used to signal the select line of a multiplexer 250. In this regard, logic 252 may be provided for processing the geometry or attribute in homogeneous coordinates, while other logic 254 may be provided for processing the geometry or attribute information in screen coordinates. The status of the w equal zero flag may be used to determine which logic is operable or effective for downstream pipeline operations. It should be appreciated that the illustration of FIG. 5 is not intended to be a physical or circuit operation, but rather a representative functional operation of how a one bit flag may be used for implementing the handling of the divide by w operation.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A method for transforming a plurality of points from a homogeneous coordinate representation, where the points are defined by x, p, and w values, wherein x represents a geometric coordinate value, p represents any arbitrary attribute value, and w represents a homogeneous coordinate value, comprising:
for each point:
determining whether the w value for the point is zero;
setting a flag and not dividing the x or p values by w, if w is zero; and
dividing each of the x and p values by w, if w is not zero.

2. In a computer graphics rendering process, a method comprising:
transforming a plurality of points from a homogeneous coordinate representation, where the points are defined by x, p, and w values, wherein x represents a geometric coordinate value, p represents any arbitrary attribute value, and w represents a homogeneous coordinate value, wherein for each point:
determining whether the w value for the point is zero;
setting a flag and not dividing the x or p values by w, if w is zero; and
dividing each of the x and p values by w, if w is not zero.

3. The method of claim 2, further comprising, in a downstream operation performed after the transforming, determining whether the flag is set, and if the flag is set performing a substitute operation for the divide by w operations of the transforming.

4. A graphics system comprising:
logic for transforming a plurality of points from a homogeneous coordinate representation, where the points are defined by x, p, and w values, wherein x represents a geometric coordinate value, p represents any arbitrary attribute value, and w represents a homogeneous coordinate value, said logic comprising:
logic for determining whether the w value for the point is zero;
logic for setting a flag and not dividing the x or p values by w, if w is zero; and
logic for dividing each of the x and p values by w, if w is not zero.

5. The graphics system of claim 4, further comprising attribute logic for performing an attribute setup operation, the attribute logic having logic tor checking the status of the flag, and performing two different attribute setup operations based on the status of the flag.

6. The graphics system of claim 5, where a first of the two different attribute setup operations is performed assuming that the attribute p was divided by w, and the second of the two different attribute setup operations is performed assuming that the attribute p was not divided by w.

7. The graphics system of claim 4, further comprising a span generator having logic for performing an edge setup operation, the span generator having logic for checking the status of the flag, and performing two different operations based on the status of the flag.

8. A graphics system comprising:
logic for determining whether w equals zero for a given point to be transformed, where w represents a homogeneous coordinate value;
logic for transforming the transformation on the given point in connection with a triangle setup operation, if w is determined to be non-zero;
logic for setting an indicator and not performing the transformation on the given point, if w is determined to be zero; and
logic operational downstream of the triangle setup operation, for checking a status of the indicator and computing an attribute associated with the given point in homogeneous coordinates, if the status of the indicator indicates that w was zero for that given point.

9. The graphics system of claim 8, wherein the indicator is a flag.

10. The graphics system of claim 8, further including logic, operational after the attribute computation, for transforming the given point into screen coordinates, if the status of the indicator indicates that w was zero for that given point.
